(19) United States
(12) Patent Application Publication
(10) Pub. No.: US 2026/0152356 A1
(43) Pub. Date: Jun. 4, 2026

(54) VACUUM VALVE FOR A VACUUM TRANSPORT SYSTEM

(71) Applicant: VAT HOLDING AG, Haag (CH)

(72) Inventors: Hanspeter FREHNER, Sevelen (CH); Martin NETZER, Bludenz (AT); Florian EHRNE, Frümsen (CH); Fabio Alejandro DUBOIS, Zürich (CH)

(21) Appl. No.: 18/249,425

(22) PCT Filed: Oct. 15, 2021
(86) PCT No.: PCT/EP2021/078571

§ 371 Date: Apr. 18, 2023

(30) Foreign Application Priority Data
Oct. 19, 2020 (DE) 10 2020 006 404.3

(51) Int. Cl. B65G 51/18; B65G 51/12; F16K 51/02

(52) U.S. Cl. CPC B65G 51/18; B65G 51/12; F16K 51/02

(57) ABSTRACT

Disclosed is a vacuum valve for gas-tight closing of a valve opening defining an opening axis for a vacuum transport system including a transport tube having a plurality of transport tube segments. The vacuum valve further includes a sealing surface surrounding the valve opening, a closure component having a circumferentially closed integral seal, and a drive unit to open and close the closure component. The seal contacts the sealing surface in a closed position. The closure axis is perpendicular to the opening axis, wherein the progressions of the sealing surface and the seal each have a first and a second main section as well as two side sections, the two main sections lie in planes which are at right angles to the opening axis and are spaced apart from one another, and are connected at two opposite main section sides in each case by one of the side sections.

The invention relates to a vacuum valve for substantially gas-tight closing of a valve opening for a vacuum transport system. Furthermore, the invention relates to a vacuum transport system and a method for venting a transport tube segment of a vacuum transport system.

Vacuum transport systems are currently still in the development phase. In each case, this is a high-speed transport system in which capsules glide along at very high speed in a (largely) evacuated tube, e.g. on guide systems, rail systems, air cushions or magnetically repelled. In the vicinity of stations, linear motors can enable high accelerations, as in a maglev train, while electrically driven compressors can generate sufficient propulsion when cruising speed is reached. Alternatively, a corresponding drive can be provided on the part of the object moving in the tube.

Such a vacuum transport system has, for example, on reinforced concrete supports with two adjacent travel tubes made of steel or other suitable materials containing metal and/or concrete, in which at least a rough or fine vacuum prevails. Instead of being arranged on supports, the tube system can also be developed underground. The vacuum is intended to enable travel speeds up to just above the speed of sound by reducing air resistance within the transport tube. Capsules or vehicles with space for several passengers can be moved or loads transported in the tubes (e.g. cars).

For example, the capsules or vehicles can be made primarily of aluminum or alternative lightweight materials and have a diameter of at least two meters, Furthermore, an unladen weight of 3 to 3.5 metric tons is proposed, and a payload of between 12 and 25 metric tons may be provided.

The transport tubes can have an inner diameter of slightly more than the capsule diameter and a wall thickness of at least 20 mm. The internal pressure can be maintained at, for example, about 100 Pascal (1 millibar), The support piers carrying the transport tubes may be positioned with an average spacing of about 30 meters and secured against earthquakes by damping elements.

Generally, it is a problem for the operation of such a vacuum transport system to create and maintain a desired vacuum inside the system. Especially during unloading or loading or removal or insertion of a transport vehicle into the transport tube, large losses of the internal vacuum can occur.

A further problem is the fulfillment of safety requirements, in particular those imposed by the authorities, so that possible hazards can be avoided during operation of the system. Particularly when transporting people, but also when transporting goods (e.g. hazardous goods), it is essential that intended safety devices enable people or goods to be recovered from the transport tube unharmed in the event of an emergency.

It is therefore the object of the present invention to solve these problems.

These objects are solved by the realization of the characterizing features of the independent claims. Features which further form the invention in an alternative or advantageous manner are to be taken from the dependent claims.

The approach of the present invention to solve the above problems is based on an integration of a plurality of vacuum valves along the transport tube. On the one hand, the vacuum valves can be used to atmospherically isolate certain station areas along the line from the tube and make them ventilated and accessible for loading and unloading. After the loading activity, the area is then closed off again, evacuated and the valves opened.

On the other hand, the valves can be provided at certain regular intervals along the line, This allows a certain section of the transport tube to be closed in an emergency and then ventilated so that a rescue of people and/or goods can be initiated.

The invention relates to a vacuum valve for gas-tight closure of a valve opening for a vacuum transport system, wherein the vacuum transport system comprises a transport tube having a plurality of transport tube segments for transporting a vehicle internally along the transport tube, wherein the valve opening defines an opening axis, and wherein the vacuum valve further comprises: a sealing surface surrounding the valve opening, a closure component for closing the valve opening in a gas-tight manner, comprising a circumferentially closed integral seal adapted to interact with the sealing surface, and a drive unit for providing such movement of the closure component relative to the valve opening that the closure component is displaceable parallel to a closure axis from an open position to a closed position and back, wherein the closure component at least partially releases the valve Opening in the open position, wherein the seal contacts the sealing surface in the closing position and closes the valve opening in a gas-tight manner, and wherein the closure axis is perpendicular to the opening axis, wherein the progressions of the sealing surface and the seal each have a first and a second main section as well as two side sections, the two main sections lying in planes which are at right angles to the opening axis and are spaced apart from one another, and being connected on two opposite main section sides in each case by one of the side sections.

In one embodiment, the side sections extend in a U-shaped manner in planes that are at right angles to the closure axis.

In another embodiment, surface normals of the sealing surface are always at right angles to the opening axis.

In another embodiment, the seal has a Y-shaped cross-section, with the two legs of the cross-section contacting the sealing surface in the closed position.

In another embodiment, the closure component, as viewed in a plane perpendicular to the opening axis, is planar in the region between the two main sections and has a shoulder that supports the seal in the first main section.

In another embodiment, the sealing surface is arranged in its second main section on the track bed and in its first main section in the shaft.

In a further embodiment, the vacuum valve comprises a valve housing. In particular, the valve housing can provide the valve opening and/or be designed to connect two transport tube segments of the vacuum transport system.

In another embodiment, the valve housing has a shaft in which the closure component is fully positioned in the open position.

In a further embodiment, the valve housing has a slot that is formed such that the closure component dips into the slot on its way from the open position to the closed position.

In a further embodiment, the slot is arranged and formed in such a way that the closure component is locked in the closed position in the direction of the opening axis by end faces on the slot.

In another embodiment, the closure component is linearly mounted in the valve housing at the side of the valve opening.

The invention further relates to a vacuum transport system comprising a transport tube having a plurality of transport tube segments for transporting a vehicle in the interior along the transport tube, wherein a negative pressure, in particular a vacuum, can be provided in the interior of the transport tube relative to the surrounding atmosphere, wherein the vacuum transport system comprises a plurality of vacuum valves each arranged between two adjacent transport tube segments according to the description herein and a controller which is designed to control two adjacent ones of the vacuum valves such that they close or open an inner volume of at least one interposed transport tube segment.

In one embodiment, the vacuum transport system comprises a venting device, wherein the controller is adapted to control the venting device such that a vacuum or prevailing negative pressure prevailing in the internal volume of the intermediate transport tube segment is cancelled by venting.

In another embodiment, the vehicle is formed as a capsule or vehicle for transporting at least one person and/or goods.

The invention further relates to a method for venting a transport tube segment of a transport tube of a vacuum transport system as described herein, comprising the steps of: decelerating a vehicle traveling in the transport tube to a standstill, closing in a gas-tight manner those vacuum valves which delimit the transport tube segment in which the vehicle has come to a standstill, venting the transport tube segment in which the vehicle is located with a venting device.

The device according to the invention is described in more detail below by means of concrete exemplary embodiments shown schematically in the drawings, purely by way of example, and further advantages of the invention are also discussed. The figures show in detail:

FIG. 1 shows an embodiment of a transport tube of a vacuum transport system;

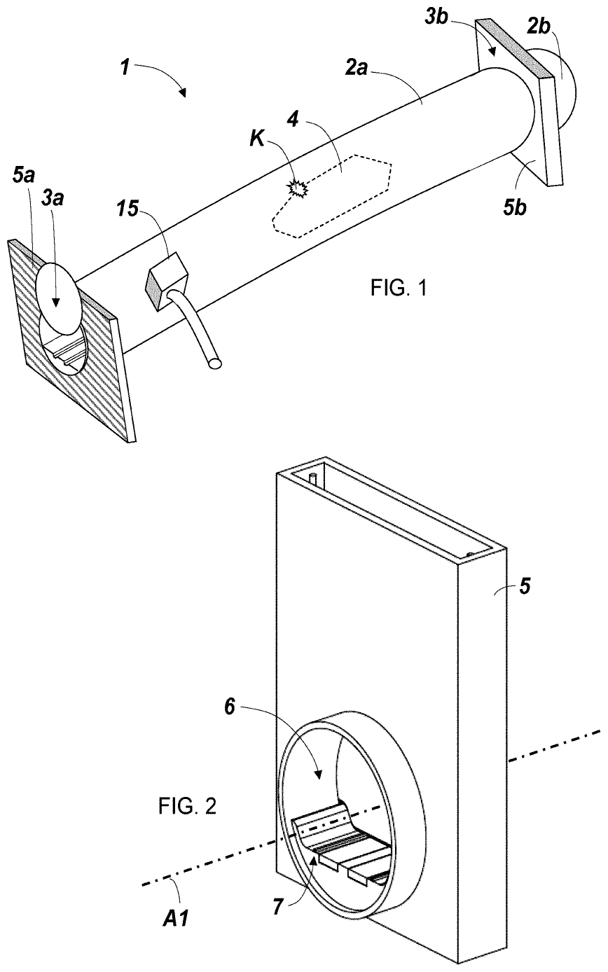

FIGS. 2-4 show an embodiment of a vacuum valve according to the invention;

FIG. 5 shows an embodiment of a closure component according to the invention;

FIG. 6 shows an embodiment of a profile of a seal according to the invention.

FIG. 1 schematically shows a section of an exemplary transport tube 1 of a vacuum transport system. The tube 1 is preferably composed of a plurality of segments (see 2a and 2b) which can be shut off from one another by vacuum valves (see 3a and 3b).

Flooding with air or equalizing pressure with the environment is relevant for safety reasons. For example, a vehicle 4 could experience a complication K such as a medical emergency of a patient, a leak in the vehicle housing, or a fire. In such an emergency situation, the vehicle 4 must stop as soon as possible. If the situation allows, the vehicle 4 could stop in a defined transport tube segment, or in any segment, in which case sensors are preferably present to detect the vehicle 4.

If the vehicle 4 comes to a stop in such a way that a valve cannot close, the next available valve can advantageously be accessed. Otherwise, a device could also be provided that moves the vehicle 4 in such a way that the valve area becomes free and the valve can close.

The vehicle 4 may be, for example, a capsule or a vehicle and may be configured to transport at least one person and/or goods.

As FIG. 2 shows in detail, the vacuum valve has, in particular, a housing 5 in which the sealing component is linearly displaceably mounted. However, the housing can also be provided by the transport tube system, i.e. the valve opening and/or the sealing surface could also be regarded as an external part, i.e. as not belonging to the vacuum valve, As a third variant, the housing 5 is part of the vacuum valve, but not the valve opening 6, which is then seen as part of the tube.

The valve opening 6 is integrated into the vacuum transport system as can be seen from the continuous rails 7. The valve opening defines an opening axis A1.

FIG. 3 shows the sealing surface 8, which extends in sections offset from one another, A first main section H11 of the sealing surface is located in the shaft 9 on the outer wall of the tube. The seal 10 rests here in the closed position. The lateral bearing and guide 11 of the closure component 12 can also be seen here, which advantageously saves space compared to conventional shaft guides which drive the closure component from above, The closure component 12 is planar throughout, except for a shoulder in the upper part which supports the seal in the main section H21. In the main section H22, the seal 10 abuts the main section H 12 of the sealing surface 8 in the closed position.

The main sections H11 and H21 lie in a first plane which is perpendicular to the opening axis A1. The main sections H12 and H22 lie in a second plane, which is also perpendicular to the opening axis A1. The first plane and the second plane are axially offset from each other (relative to the opening axis A1). This offset is bridged by the side sections, which are hidden here but will be explained in more detail with reference to FIG. 5.

The sealing surface 8 surrounds the valve opening 6 and the circumferentially closed, integral seal 10 is consequently configured to cooperate with the sealing surface 8 so that the valve opening can be closed in a gas-tight manner.

A drive unit 13 provides such a movement of the closure component 12 relative to the valve opening that the closure component can be adjusted parallel to the closure axis A2 from the open position to the closed position and back. The closure axis A2 is perpendicular to the opening axis A1,

When the vacuum valve is fully open, the closure component 12 is fully immersed in the shaft 9 through the slot 14.

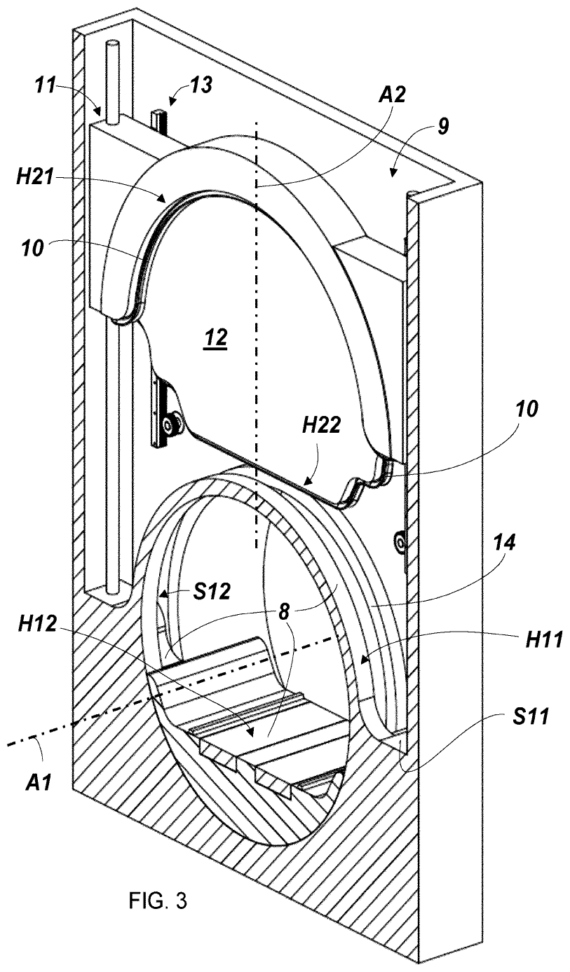

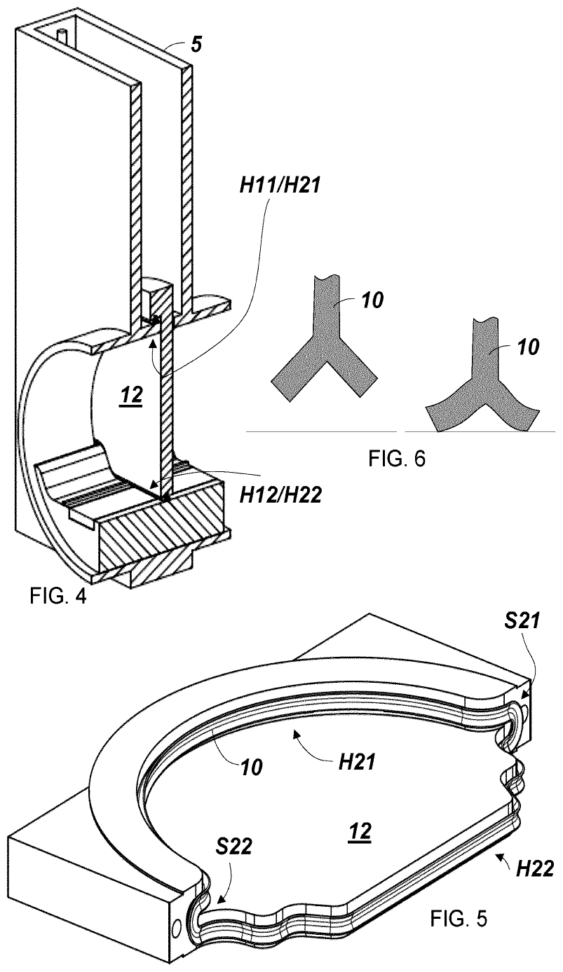

FIG. 4 shows a sectional view of the vacuum valve in the closed position. Here, the aforementioned shoulder in the closure component 12 can be clearly seen in the upper area, which ultimately also provides for the offset of the main sections H21 and H22.

On its way from the open position to the closed position, the sealing component with the flat area dips through the slot 14 into the tube. The seal then contacts the sealing surface 8 in its first and second main sections H21 and H22 at their respective first and second main sections H11 and H12, thereby closing the valve opening in a gas-tight manner.

An example of how the seal 10 is then applied to the sealing surface 8 is shown in FIG. 6. In particular, the seal 10 has a sealing lip with a Y-shaped cross-section or profile. By pressing against the sealing surface 8, the Y-limbs spread open, which promises additional security of sealing when the high pressure difference occurs during flooding of the tube segment. The (not necessarily symmetrical) Y-profile also ensures that sealing is possible in both directions.

However, such a Y-profile of the seal 10 is not mandatory. In other embodiments, the seal has any other type of profile, such as a circular, rectangular, triangular, square, polygonal, labyrinth, U-shaped, W-shaped, or M-shaped profile.

The pressure difference resulting from flooding of the segment also causes a very high force to be exerted on the closure component 12. The fact that the slot 14 allows little or no play in the immersed closure component 12 means that it is locked or held in place by the end faces of the slot 14, this over the entire first main section.

The geometry of the seal circumference is now shown in detail in FIG. 5. Here, the side sections S21 and S22 of the seal extend in an exemplary U-shape in planes which are perpendicular to the closure axis A2 and parallel to the opening axis A1, respectively. Side sections of the sealing surface S11 and S12 extend accordingly (see FIG. 3). The limbs of the U-shaped sections thereby connect the two main sections of the seal or sealing surface. Thus, the axial offset is created, allowing the valve to be closed by a vertical feed (along the closure axis).

The surface normals of the sealing surface 8 or the seal 10 are always at right angles to the opening axis A1. Therefore, at all locations of the circumferential seal, sealing is always perpendicular to the pressure exerted, In the direction of contact pressure, the seal itself is therefore never deflected or changed by the pressure difference-it is independent of the flooding. Retention of the closure component 12 is uncoupled because this is taken over by the end faces of the slot 14.

In its second main section H 22, the seal 10 and correspondingly the course of the closure component 12 are designed to seal against the track bed as sealing surface 8. Specifically, this can mean that thus the shape of the closure component 12 and/or that of the seal 10 are adapted to a track bed. However, it can also mean, as in the case shown in FIG. 4, that an uneven track bed is bridged and sealed by a closure component 12 and seal 10 that are flat in this area by means of resilient “nestling” of the sealing material. In other words, in one embodiment, the seal 10 is thus configured to seal the valve opening in a gas-tight manner by elastically deforming the seal to form a gas-tight seal in the second main section with respect to a track bed structure encompassed by the sealing surface. An uneven track bed, i.e. a track bed structure of any kind that is not a flat surface, may or may not include a rail as shown in FIGS. 2-4. It may also be track depressions or a combination of elevations and depressions, in which case the seal 10 per se at least partially compensates for such unevenness by resiliently conforming to the shape.

Other forms of a sealing surface are of course also conceivable, for example a straight form, so that the second main section H22 of the seal can at least partially dip into a flat groove in the track bed as a sealing surface (not shown). Such grooves do not normally interfere with the vehicle 4, since magnetic guides are preferably used, and in particular also because the “plate”, i.e. the closure component 12 can be designed to be very thin, which means that the groove in the floor can be very thin. Such an additional groove would additionally lock the closure component in the axial direction.

The transport tube segments of a vacuum transport system can each be connected to the housing 5, as shown in FIG. 1. A controller (not shown), in particular a computer, controls two adjacent ones of the vacuum valves 3a and 3b, so that they close or open an inner volume of the interposed transport tube segment. A venting device 15 is then controlled, e.g. also by the controller, to cancel a vacuum or negative pressure prevailing in the inner volume of the intermediate transport tube segment 2a by venting.

In particular, an unloading/reloading hatch, e.g. for a vehicle, is to be provided in some or all of the tube segments (not shown in FIG. 1).

When reference is made to “two adjacent vacuum valves”, this of course also includes the case where two segments are flooded simultaneously by closing two valves, between which there are two tube segments and one valve remaining open, or even three tube segments and two valves remaining open, and so on.

It is understood that the figures shown are only schematic illustrations of possible exemplary embodiments. According to the invention, the various approaches can also be combined with each other and with valves for closing process volumes under vacuum conditions of the prior art.

1. A vacuum valve for gas-tight closing a valve opening for a vacuum transport system, wherein the vacuum transport system comprises a transport tube having a plurality of transport tube segments for transporting a vehicle internally along the transport tube, wherein the valve opening defines an opening axis, comprising:
a sealing surface surrounding the valve opening,
a closure component for closing the valve opening in a gas-tight manner, comprising a circumferentially closed integral seal adapted to interact with the sealing surface, and
a drive unit for providing such movement of the closure component relative to the valve opening that the closure component is displaceable parallel to a closure axis from an open position to a closed position and back, wherein the closure component at least partially releases the valve opening in the open position, wherein the seal contacts the sealing surface in the closed position and closes the valve opening in a gas-tight manner, and wherein the closure axis is perpendicular to the opening axis, wherein
progressions of the sealing surface and the seal each have a first and second main section and two side sections,
the two main sections lie in planes which are at right angles to the opening axis and are spaced apart from each other, and are connected at two opposite main section sides in each case by one of the side sections.

2. The vacuum valve according to claim 1, wherein the side sections extend in a U-shaped manner in planes which are at right angles to the closure axis.

3. The vacuum valve according to claim 1, wherein surface normal of the sealing surface are always at right angles to the opening axis.

4. The vacuum valve according to claim 1, wherein the seal has a Y-shaped cross-section, wherein two legs of the cross-section contact the sealing surface in the closed position.

5. The vacuum valve according to claim 1, wherein the closure component, as viewed in a plane perpendicular to the opening axis, is planar in a region between the two main sections and has a shoulder which supports the seal in the first main section.

6. The vacuum valve according to claim 1, comprising a valve housing.

7. The vacuum valve according to claim 6, wherein the valve housing comprises a shaft in which the closure component is fully positioned in the open position.

8. The vacuum valve according to claim 7, wherein the sealing surface is arranged in its second main section on a track bed and in its first main section in the shaft.

9. The vacuum valve according to claim 6, wherein the valve housing has a slot which is formed such that the closure component dips into the slot on its way from the open position to the closed position.

10. The vacuum valve according to claim 6, wherein a slot is arranged and formed in such a way that the closure component is locked in the closed position in a direction of the opening axis by end faces on the slot.

11. The vacuum valve according to claim 6, wherein the closure component is linearly supported laterally of the valve opening in the valve housing.

12. The vacuum transport system according to claim 1 having a transport tube with a plurality of transport tube segments for transporting a vehicle in an interior along the transport tube, wherein a negative pressure, in particular a vacuum, can be provided in the interior of the transport tube relative to a surrounding atmosphere, and wherein:
a plurality of vacuum valves are each arranged between two adjacent transport tube segments, and
a controller is configured to control two adjacent ones of the vacuum valves to close or open an inner volume of at least one interposed transport tube segment.

13. The vacuum transport system according to claim 12, comprising a venting device, wherein the controller is adapted to control the venting device such that a vacuum or negative pressure prevailing in the inner volume of an intermediate transport tube segment is cancelled by venting.

14. The vacuum transport system according to claim 13, wherein the vehicle is formed as a capsule or a vehicle for transporting at least one person and/or goods.

15. A method for venting a transport tube segment of a transport tube of a vacuum transport system, comprising:
braking a vehicle traveling in the transport tube to a standstill,
gas-tight closing of vacuum valves which delimit the transport tube segment in which the vehicle has come to a standstill, and
venting the transport tube segment in which the vehicle is located with a venting device.
